(19) United States
(12) Patent Application Publication
(10) Pub. No.: US 2010/0223144 A1
(43) Pub. Date: Sep. 2, 2010

(54) SYSTEMS FOR GENERATING ONLINE ADVERTISEMENTS OFFERING DYNAMIC CONTENT RELEVANT DOMAIN NAMES FOR REGISTRATION

(75) Inventor: Yong Lee, Chandler, AZ (US)

Correspondence Address: GO DADDY GROUP, INC., 14455 NORTH HAYDEN ROAD, SUITE 219, SCOTTSDALE, AZ, 85260, US

(73) Assignee: THE GO DADDY GROUP, INC., Scottsdale, AZ (US)

(21) Appl. No.: 12/395,308

(22) Filed: Feb. 27, 2009

(51) Int. Cl. G06Q 30/00

(52) U.S. Cl. 705/14.73; 705/1.1

(57) ABSTRACT

Systems of the present inventions allow for generating online advertisements offering dynamic content relevant domain names for registration. An exemplary system may comprise an online advertisement generation module (running on at least one server computer communicatively coupled to a network), which generates at least one online advertisement that may offer at least one domain name for registration, the domain name(s) being based upon the content of a website.

### CROSS REFERENCE TO RELATED PATENT APPLICATIONS

This patent application is related to U.S. patent application Ser. No. ______ entitled: “Dynamic Content Relevant Domain Name Suggestion in Online Advertising” concurrently filed herewith and also assigned to The Go Daddy Group, Inc.

This patent application is related to U.S. patent application Ser. No. ______ entitled: “Generating Online Advertisements Based upon Dynamic Content Relevant Domain Names” concurrently filed herewith and also assigned to The Go Daddy Group, Inc.

### FIELD OF THE INVENTION

The present inventions generally relate to online advertising and, more particularly, systems and methods for generating online advertisements offering dynamic content relevant domain names for registration.

### SUMMARY OF THE INVENTION

An example embodiment of a method for generating online advertisements offering dynamic content relevant domain names for registration may comprise generating at least one domain name, which may be based upon the dynamic content of a website. If the domain name is determined to be available for registration, an online advertisement offering the domain name for registration may be generated. The online advertisement then may be displayed on the website.

Another example embodiment of a method for generating online advertisements offering dynamic content relevant domain names for registration may comprise the steps of requesting at least one available domain name (which may be based upon the dynamic content on a website), receiving the domain name, incorporating the domain name into an online advertisement, and displaying the online advertisement on the website.

An example embodiment of a system for generating online advertisements offering dynamic content relevant domain names for registration may comprise an online advertisement generation module (running on at least one server computer communicatively coupled to a network), which generates at least one online advertisement that may offer at least one domain name (that is based upon the dynamic content of a website) for registration.

The above features and advantages of the present inventions will be better understood from the following detailed description taken in conjunction with the accompanying drawings.

### BRIEF DESCRIPTION OF THE DRAWINGS

FIG. 1 is a flow diagram illustrating a possible embodiment of a method for generating online advertisements offering dynamic content relevant domain names for registration.

FIG. 2 is a flow diagram illustrating a possible embodiment of a method for generating online advertisements offering dynamic content relevant domain names for registration.

FIG. 3 is a flow diagram illustrating a possible embodiment of a method for generating online advertisements offering dynamic content relevant domain names for registration.

FIG. 4 is a flow diagram illustrating a possible embodiment of a method for generating online advertisements offering dynamic content relevant domain names for registration.

FIG. 5 is a flow diagram illustrating a possible embodiment of a method for generating online advertisements offering dynamic content relevant domain names for registration.

FIG. 6 is a flow diagram illustrating a possible embodiment of a method for generating online advertisements offering dynamic content relevant domain names for registration.

FIG. 7 is a flow diagram illustrating a possible embodiment of a method for generating online advertisements offering dynamic content relevant domain names for registration.

FIG. 8 is a flow diagram illustrating a possible embodiment of a method for generating online advertisements offering dynamic content relevant domain names for registration.

FIG. 9 is a flow diagram illustrating a possible embodiment of a method for generating online advertisements offering dynamic content relevant domain names for registration.

FIG. 10 is a flow diagram illustrating a possible embodiment of a method for generating online advertisements offering dynamic content relevant domain names for registration.

FIG. 11 is a flow diagram illustrating a possible embodiment of a method for generating online advertisements offering dynamic content relevant domain names for registration.

FIG. 12 is a flow diagram illustrating a possible embodiment of a method for generating online advertisements offering dynamic content relevant domain names for registration.

FIG. 13 illustrates a possible embodiment of a system for generating online advertisements offering dynamic content relevant domain names for registration.

FIG. 14 illustrates a possible embodiment of a system for generating online advertisements offering dynamic content relevant domain names for registration.

FIG. 15 illustrates a possible embodiment of a system for generating online advertisements offering dynamic content relevant domain names for registration.

FIG. 16 illustrates a possible embodiment of a system for generating online advertisements offering dynamic content relevant domain names for registration.

FIG. 17 illustrates a possible embodiment of a system for generating online advertisements offering dynamic content relevant domain names for registration.

FIG. 18 illustrates a possible embodiment of a system for generating online advertisements offering dynamic content relevant domain names for registration.

FIG. 19 illustrates a possible embodiment of a system for generating online advertisements offering dynamic content relevant domain names for registration.

FIG. 20 illustrates a possible embodiment of a system for generating online advertisements offering dynamic content relevant domain names for registration.

FIG. 21 illustrates a possible embodiment of a system for generating online advertisements offering dynamic content relevant domain names for registration.

### DETAILED DESCRIPTION

The present inventions will now be discussed in detail with regard to the attached drawing figures which were briefly described above. In the following description, numerous specific details are set forth illustrating the Applicant's best mode for practicing the inventions and enabling one of ordinary skill in the art to make and use the inventions. It will be obvious, however, to one skilled in the art that the present inventions may be practiced without many of these specific details. In other instances, well-known machines, structures, and method steps have not been described in particular detail in order to avoid unnecessarily obscuring the present inventions. Unless otherwise indicated, like parts and method steps are referred to with like reference numerals.

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users. Hundreds of millions of people around the world have access to computers connected to the Internet via Internet Service Providers (ISPs). Content providers place multimedia information (e.g., text, graphics, audio, video, animation, and other forms of data) at specific locations on the Internet referred to as webpages. Websites comprise a collection of connected, or otherwise related, webpages. The combination of all the websites and their corresponding webpages on the Internet is generally known as the World Wide Web (WWW) or simply the Web.

For Internet users and businesses alike, the Internet continues to be increasingly valuable. People increasingly use the Web for everyday tasks, from social networking, shopping, banking, and paying bills to consuming media and entertainment. E-commerce is growing, with businesses delivering more services and content across the Internet, communicating and collaborating online, and inventing new ways to connect with each other.

Prevalent on the Web are multimedia websites, some of which may offer and sell goods and services to individuals and organizations. Websites may consist of a single webpage, but typically consist of multiple interconnected and related webpages. Websites, unless extremely large and complex or have unusual traffic demands, typically reside on a single server and are prepared and maintained by a single individual or entity. Menus and links may be used to move between different webpages within the website or to move to a different website as is known in the art. The interconnectivity of webpages enabled by the Internet can make it difficult for Internet users to tell where one website ends and another begins.

Websites may be created using HyperText Markup Language (HTML) to generate a standard set of tags that define how the webpages for the website are to be displayed. Users of the Internet may access content providers' websites using software known as an Internet browser, such as MICROSOFT INTERNET EXPLORER or MOZILLA FIREFOX. After the browser has located the desired webpage, it requests and receives information from the webpage, typically in the form of an HTML document, and then displays the webpage content for the user. The user then may view other webpages at the same website or move to an entirely different website using the browser.

Browsers are able to locate specific websites because each website, resource, and computer on the Internet has a unique Internet Protocol (IP) address. Presently, there are two standards for IP addresses. The older IP address standard, often called IP Version 4 (IPv4), is a 32-bit binary number, which is typically shown in dotted decimal notation, where four 8-bit bytes are separated by a dot from each other (e.g., 64.202.167.32). The notation is used to improve human readability. The newer IP address standard, often called IP Version 6 (IPv6) or Next Generation Internet Protocol (IPng), is a 128-bit binary number. The standard human readable notation for IPv6 addresses presents the address as eight 16-bit hexadecimal words, each separated by a colon (e.g., 2EDC:BA98:0332:0000:CF8A:000C:2154:7313).

IP addresses, however, even in human readable notation, are difficult for people to remember and use. A Uniform Resource Locator (URL) is much easier to remember and may be used to point to any computer, directory, or file on the Internet. A browser is able to access a website on the Internet through the use of a URL. The URL may include a Hypertext Transfer Protocol (HTTP) request combined with the website's Internet address, also known as the website's domain name. An example of a URL with a HTTP request and domain name is: http://www.companyname.com. In this example, the “http” identifies the URL as a HTTP request and the “companyname.com” is the domain name.

Domain names are much easier to remember and use than their corresponding IP addresses. The Internet Corporation for Assigned Names and Numbers (ICANN) approves some Generic Top-Level Domains (gTLD) and delegates the responsibility to a particular organization (a “registry”) for maintaining an authoritative source for the registered domain names within a TLD and their corresponding IP addresses. For certain TLDs (e.g., .biz, .info, .name, and .org) the registry is also the authoritative source for contact information related to the domain name and is referred to as a “thick” registry. For other TLDs (e.g., .com and .net) only the domain name, registrar identification, and name server information is stored within the registry, and a registrar is the authoritative source for the contact information related to the domain name. Such registries are referred to as “thin” registries. Most gTLDs are organized through a central domain name Shared Registration System (SRS) based on their TLD.

The process for registering a domain name with .com, .net, .org, and some other TLDs allows an Internet user to use an ICANN-accredited registrar to register their domain name. For example, if an Internet user, John Doe, wishes to register the domain name “mycompany.com,” John Doe may initially determine whether the desired domain name is available by contacting a domain name registrar. The Internet user may make this contact using the registrar's webpage and typing the desired domain name into a field on the registrar's webpage created for this purpose. Upon receiving the request from the Internet user, the registrar may ascertain whether “mycompany.com” has already been registered by checking the SRS database associated with the TLD of the domain name. The results of the search then may be displayed on the webpage to thereby notify the Internet user of the availability of the domain name. If the domain name is available, the Internet user may proceed with the registration process. If the domain name is not available for registration, the Internet user may keep selecting alternative domain names until an available domain name is found.

Applicant has noticed that Internet users often have difficulty identifying an available domain name that they may wish to register. Desired domain names are often already registered and the available domain names that may be suggested by a registrar may not be satisfactory. Applicant has therefore determined that presently-existing systems and methods do not provide optimal means for suggesting relevant domain names of interest to the potential registrants. For these reasons, there is a need for the systems and methods for generating online advertisements offering dynamic content relevant domain names for registration (and related functionality) as described herein.

Dynamic Content Relevant Domain Name Suggestion in Online Advertising

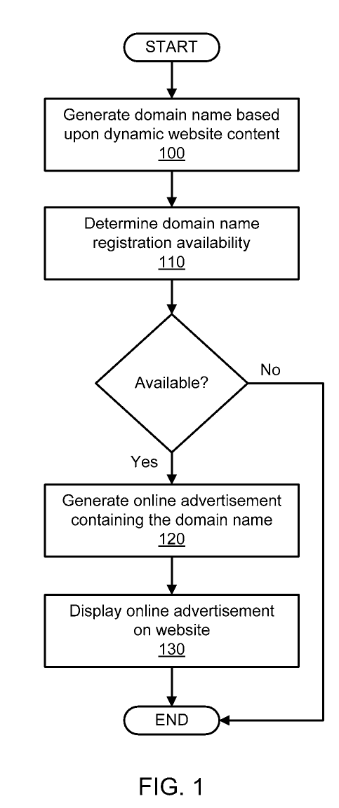

FIG. 1 illustrates a streamlined embodiment of a method for generating online advertisements offering dynamic content relevant domain names for registration. This method (and all methods described herein) may be performed by at least one microprocessor on at least one server executing a plurality of instructions stored on at least one computer-readable media. The method may comprise the steps of generating at least one domain name based upon a dynamic content on a website (Step 100), determining whether the domain name(s) is/are available for registration (Step 110), generating an online advertisement that may include the domain name(s) (if determined to be available for registration) (Step 120), and displaying the online advertisement on the website (Step 130).

As a non-limiting example, the method illustrated in FIG. 1 (and all methods described herein) may be performed by any central processing unit (CPU) in any computing system, such as a microprocessor running on a server, and executing instructions stored (perhaps as scripts and/or software) in computer-readable media accessible to the CPU, such as a hard disk drive on a server, which may be communicatively coupled to a network (e.g., the Internet).

The server, perhaps via domain name generation scripts and/or software running on it, may generate at least one domain name, which may be based upon the dynamic content of a website accessible via the network (Step 100). Dynamic content may comprise any content that is not static. It may comprise any website content (e.g., text, images, photos, video, audio, flash etc.) that may change over time, perhaps in response to different contexts or conditions. Dynamic content may be generated, as a non-limiting example, via client and/or server-side scripting. Commonly-known examples of dynamic content include video available via YOUTUBE.COM and/or HULU.COM's websites. The illustrated embodiments may function with any and all sources of dynamic content.

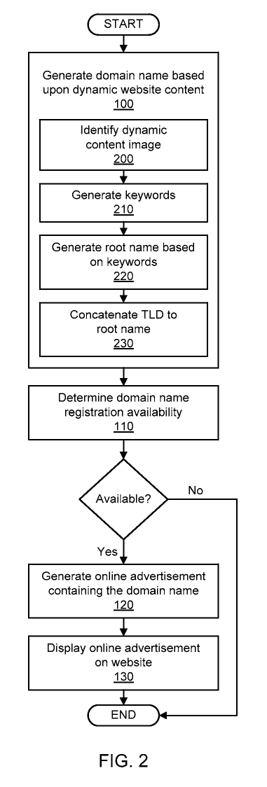

Any method of generating a domain name that may relate in any manner to the website's dynamic content may be used. As a non-limiting example (and as illustrated in FIG. 2), the generating step (Step 100) may be accomplished by identifying at least one image in the website's dynamic content (Step 200). Any method of image and/or object recognition maybe used that is known in the art or may be developed in the future including, but not limited to the use of image and/or object recognition software. As a non-limiting example, such software may perform image recognition by acquiring an image from a source (e.g., capturing a frame from the website's dynamic content, perhaps a video frame), comparing the acquired image to models in a library, and determining if a match has been made. The recognized image may comprise an object type (e.g., human being, automobile, corporate logo, etc.), while the recognized properties of the object may comprise any label further describing the object (e.g., tall and female, red and sports car, or GODADDY.COM's orange and green corporate logo). Commercially available image and object recognition systems may be used, such as SNVISION SDK offered by SPIKENET TECHNOLOGIES or VIPR TECHNOLOGY offered by EVOLUTION ROBOTICS. Alternatively, proprietary, commercially and/or open source image recognition software may be used.

Once an image is identified from the dynamic content (Step 200), a plurality of keywords may be generated that may be relevant to the identified image (Step 210). The keywords may be relevant to the recognized image or object itself (e.g., “automobile”) or may be relevant to any property of the image or object ascertained during the recognition process (e.g., “red” or “sports car”). As a non-limiting example, if a video playing on a website (the dynamic content) displays a red sports car driving on a racetrack, software and/or scripts running on the server may generate, among others, the keywords “automobile,” “red,” “striped,” and/or “sportscar.”

A root name may then be generated that may be based on at least one of the keywords (Step 220). The root name may comprise any combination, sequence, or order of any of the keywords generated in Step 210. Continuing with the example of the preceding paragraph, scripts and/or software running on the server may generate a root name by combining the keywords “automobile” and “red” into the root name “redautomobile,” and/or combining the keywords “striped” and “sportscar” into the root name “stripedsportscar.” Alternatively, the root name may be generated by combining at least one of the keywords with at least one text string, which may comprise any combination of characters including, but not limited to randomly generated text string or a text string based on a concept in the website. Any method of generating a concept-relevant text string may be used including, but not limited to, those set forth in U.S. patent application Ser. No. 12/055,905 entitled: “Suggesting Concept-Based Top-Level Domain Names,” which is assigned to The Go Daddy Group, Inc. and incorporated herein by reference.

A top-level domain (TLD) then may be concatenated to the root name to generate a domain name (Step 230). For example, the TLD “.com” may be concatenated to the root name “redautomobile,” generating the domain name “redautomobile.com” or the TLD “.info” may be concatenated to the root name “stripedsportscar,” generating the domain name “stripedsportscar.info.” As a non-limiting example, a software-based random TLD generator may be implemented to select TLDs to concatenate to root names. Alternatively, software running on the server may generate the most appropriate TLD based upon the dynamic content of the website, keywords, or root name. Any method of suggesting a concept-relevant TLD may be used including, but not limited to, those set forth in U.S. patent application Ser. No. 12/055,905 entitled: “Suggesting Concept-Based Top-Level Domain Names,” which is assigned to The Go Daddy Group, Inc. and incorporated herein by reference.

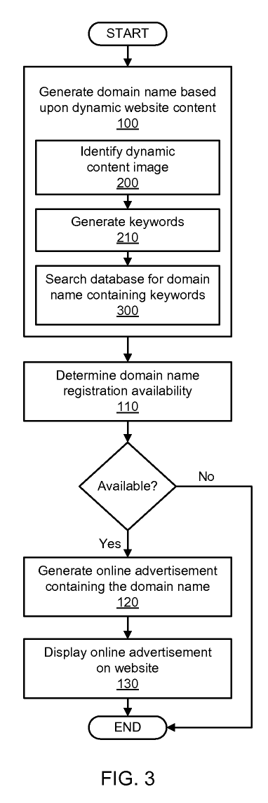

As another non-limiting example (and as illustrated in FIG. 3), the generating step (Step 100) may be accomplished by identifying an image in the website's dynamic content (Step 200), generating keywords relevant to the image (Step 210), and then searching a domain names database for at least one domain name comprising at least one of the keywords (Step 300). Steps 200 and 210 may be accomplished as described in detail above. In this example embodiment, however, once keywords have been generated (Step 210), a domain names database may be searched, perhaps by scripts and/or software running on a server, for at least one domain name that may comprise at least one of the keywords (Step 300). This embodiment enables a potential registrant to identify those domain names that, although already registered, may be available for re-registration, perhaps because their registration may expire shortly, or because the domain name registrant wishes to resell his interest in the domain name. The domain name database may be communicatively coupled with the network and may store a plurality of domain names, perhaps those whose registrations are about to expire or are being offered for resale, perhaps via a domain name auction service, such as GODADDY.COM's GODADDY AUCTIONS service.

The registration availability of the domain name then may be determined (Step 110), perhaps by software and/or scripts running on a server ascertaining whether the domain name (e.g., “redautomobile.com”) has already been registered by checking the SRS database associated with the TLD of the domain name (.com in the instant example). As an additional non-limiting example, any of the systems and/or methods may be used as described in U.S. Patent Application Publication No. 2004-0199520 entitled: “Method for Checking the Availability of a Domain Name,” which is assigned to The Go Daddy Group, Inc. and incorporated herein by reference. Alternatively, any method of determining domain name registration availability known in the art or developed in the future may be used.

If the domain name is determined to be available for registration, an online advertisement offering the domain name for registration may be generated (Step 120) by any means of generating and/or publishing an online advertisement known in the art or developed in the future including, but not limited to, computer-implemented software for posting data on a website. The online advertisement may comprise any form of online advertising including, but not limited to, text, graphics, video, and/or audio data. The online advertisement also could comprise a hyperlink to another website, another website, and/or both. Among other types, the online advertisement may be a pop-up, pop-under, banner, rich media (i.e., interactive), contextual, targeted, and/or focused ad that may offer the domain name for registration.

As another non-limiting example, the online advertisement may be generated via a contextual advertising program. With such programs, an advertising service (e.g., GOOGLE) may maintain a database of advertisers who specify keywords that relate to their advertisements. The advertisers pay the advertising service for inclusion in the database. A website provider may partner with the advertising service to provide advertising content on its website. When Internet users access the website and click on an advertisement, the advertising service pays the website provider a fee. This advertising model is known as “pay per click.” Examples of such programs include GODADDY.COM CASHPARKING, GOOGLE ADSENSE AND ADWORDS, YAHOO! SEARCH MARKETING, and MICROSOFT ADCENTER. Usually, the advertising service pays the website provider based on how many links have been visited (e.g., pay per click) and on how beneficial those visits have been. Online advertisements may be dynamically generated and provided, perhaps by the advertising service, which may provide available domain names (relevant to the website's dynamic content) for registration by any Internet user who clicks on the advertisement.

If available, the domain name then may be provided for registration, perhaps by displaying the online advertisement on the website (Step 130). The online advertisement may contain a link to a domain name registrar's website, where the registration may be completed. As a non-limiting example, domain name registration may be accomplished by any domain name registration method known in the art or developed in the future, perhaps via a website-enabled domain name purchase and registration system, such as that described in detail above and/or may be available on GODADDY.COM's website. Alternatively, domain name registration may be accomplished via human to human communication, perhaps via a telephone call or in-person meeting. Domain names may be registered by, as non-limiting examples, any individual or entity including, but not limited to a domain name registry, domain name registrar, hosting provider, and/or software application developer or distributor.

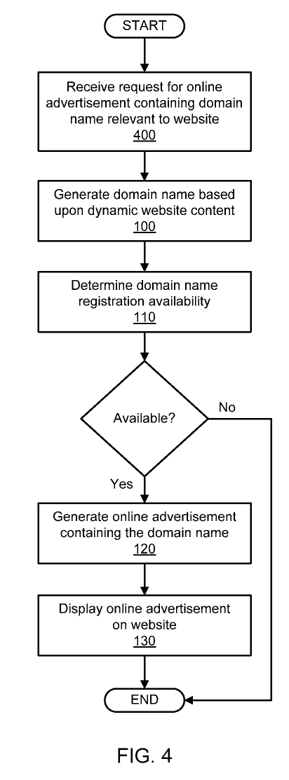

FIG. 4 builds upon the method illustrated in FIG. 1 by adding the step of, prior to Step 100, receiving a request for an online advertisement offering at least one domain name for registration, wherein the domain name may be based upon a website's dynamic content (Step 400). The request may comprise any communication seeking the described online advertisement and may come from any individual or entity having access to a network (e.g., the Internet) that may wish to place online advertisements offering such domain names for registration. Thus, the request may comprise any electronic request received at a server including, but not limited to, electronic requests such as a Hyper Text Transfer Protocol (HTTP) request, email message, and/or Short Message Service (SMS) message (i.e., text message). As a specific non-limiting example, the request may comprise an HTTP request initiated by a website provider who wishes to monetize the dynamic content on his website. The request may be received by any individual or entity having the ability to generate and provide the described online advertisement, such as the above-described advertising service.

Alternatively, the electronic request may comprise a function call on a domain name generation module having an exposed Applications Programming Interface (API). As described in detail below, a domain name generation module may be stored in the memory of—and run on—at least one server and may comprise any software and/or scripts containing instructions that, when executed by the server's microprocessor, cause the microprocessor to generate domain names based upon dynamic content on the website. An API is a software-to-software interface that specifies the protocol defining how independent computer programs interact or communicate with each other. The API may allow the requesting entity's software to communicate and interact with the domain name generation module—perhaps over a network such as the Internet—through a series of function calls (requests for services). It may comprise an interface provided by the domain name generation module to support function calls made of the domain name generation module by other computer programs, perhaps those utilized by the requesting party to request the described online advertisements.

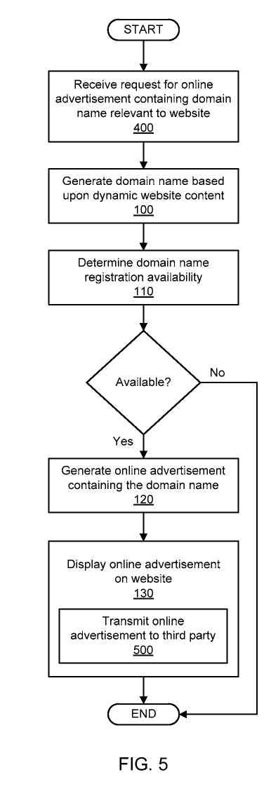

FIG. 5 builds upon the method illustrated in FIG. 4, wherein the displaying step (Step 130) further comprises the step of transmitting the online advertisement to a third party for display on the website (Step 500). Thus, the online advertisement generating entity may directly display the online advertisement on the website (as described above), or may transmit the advertisement (perhaps to the requesting entity) for publication on the website. Online advertisements may be transmitted, perhaps via a network such as the Internet, according to any data transmission protocol known in the art or developed in the future including, but not limited to file transfer protocol (FTP).

Viable data transfer methods can generally be classified in two categories: (1) “pull-based” data transfers where the receiver initiates a data transmission request; and (2) “push-based” data transfers where the sender initiates a data transmission request. Both types are expressly included in the embodiments illustrated herein, which also may include transparent data transfers over network file systems, explicit file transfers from dedicated file-transfer services like FTP or HTTP, distributed file transfers over peer-to-peer networks, file transfers over instant messaging systems, file transfers between computers and peripheral devices, and/or file transfers over direct modem or serial (null modem) links, such as XMODEM, YMODEM and ZMODEM. Data streaming technology also may be used to effectuate data transfer. A data stream may be, for example, a sequence of digitally encoded coherent signals (packets of data) used to transmit or receive information that is in transmission. Any data transfer protocol known in the art or developed in the future may be used including, but not limited to: (1) those used with TCP/IP (e.g., FTAM, FTP, HTTP, RCP, SFTP, SCP, or FASTCopy); (2) those used with UDP (e.g., TFTP, FSP, UFTP, or MFTP); (3) those used with direct modem connections; (4) HTTP streaming; (5) Tubular Data Stream Protocol (TDSP); (6) Stream Control Transmission Protocol (SCTP); and/or (7) Real Time Streaming Protocol (RTSP).

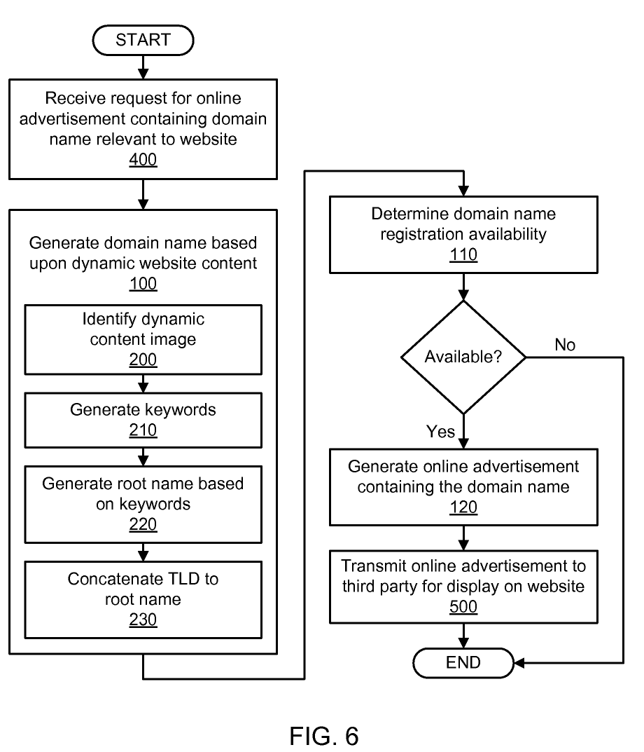

FIG. 6 illustrates a highly-detailed method embodiment. It may comprise the steps of receiving a request for an online advertisement that may offer domain names for registration that may be based upon a website's dynamic content (Step 400), generating the domain name(s) (Step 100) by: (1) identifying at least one image in the dynamic content (Step 200); (2) generating keywords relevant to the image (Step 210); (3) generating a root name comprising at least one keyword (Step 220); and (4) concatenating a top level domain to the root name (Step 230), determining whether the domain name(s) are available for registration (Step 110), generating the online advertisement (if the domain name(s) are available for registration) (Step 120), and transmitting the online advertisement to a third party for display on the website (Step 500).

Generating Online Advertisements Based upon Dynamic Content Relevant Domain Names

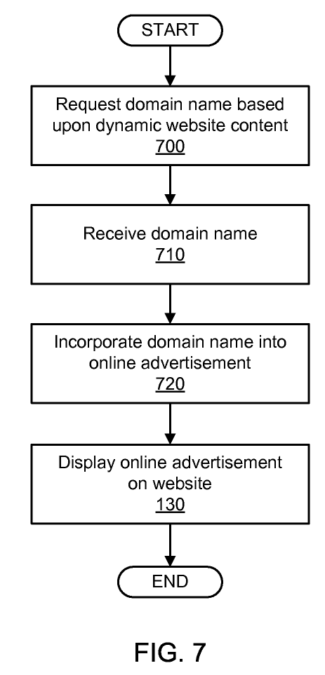

FIGS. 7 through 9 illustrate methods for generating online advertisements offering dynamic content relevant domain names for registration that may provide solutions for an individual or entity having the capacity to generate online advertisements, but perhaps not the ability to generate domain names relevant to a website's dynamic content. As a non-limiting example, these embodiments may be particularly useful to an advertising service that may not also be a domain name registrar, registry, or reseller.

FIG. 7 illustrates a possible embodiment of a method that may comprise the steps of requesting at least one domain name (that may be based upon a website's dynamic content and available for registration), (Step 700), receiving the requested domain name(s) (Step 710), incorporating the domain name(s) into an online advertisement (Step 720), and displaying the online advertisement on the website (Step 130).

Domain names may be requested (Step 700) via any method or means for requesting a domain name known in the art or developed in the future. As a non-limiting example, the request may come from any individual or entity having access to a network (perhaps the Internet) that may wish to obtain a domain name based upon a website's dynamic content. The request may comprise any electronic request received by a server including, but not limited to, a Hyper Text Transfer Protocol (HTTP) request, email message, and/or Short Message Service (SMS) message (i.e., text message). The request may comprise any communication seeking any information relating to the requested domain name. As a non-limiting example, the request may comprise an HTTP request initiated by a website provider who wishes to monetize the dynamic content on his website. The request may be received by any individual or entity having the ability to generate and provide the described online advertisement, such as the above-described advertising service. Alternatively, the electronic request may comprise a function call on a domain name generation module having an exposed Applications Programming Interface (API) as described in detail above.

The domain name then may be received (Step 710), perhaps in like electronic format as the request (i.e., an HTTP request may receive an HTTP response). Received data identifying the domain name may be in any cognizable data format known in the art or developed in the future. And such data may be received via any method or means for receiving the domain name including, but not limited to, the data and file transfer protocols described in detail above.

After the domain name is received (Step 710), it may be incorporated into an online advertisement (Step 720), which may offer the domain name for registration. The online advertisement may comprise any of the types described in detail above. Available, relevant domain names may be incorporated into the advertisements via any technological means for listing domain names in an online advertisement known in the art or developed in the future including, but not limited to the use of JavaScript, Flash, XML, HTML, streaming, text editing, audio, video, or image technologies. The completed online advertisement may then be displayed on the website (Step 130). The displayed online advertisement may list available domain names and may contain a link to a domain name registrar's website, where the registration may be completed. As a non-limiting example, domain name registration may be accomplished by any domain name registration method known in the art or developed in the future, perhaps via a website-enabled domain name purchase and registration system, such as that described in detail above.

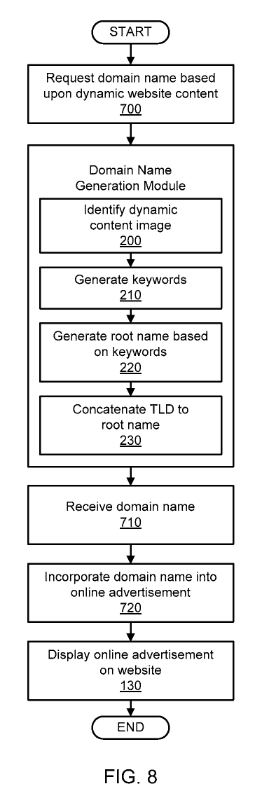

FIG. 8 builds upon the method illustrated in FIG. 7, wherein, prior to domain name receipt (Step 710), a domain name generation module (described in detail below) may identify at least one image in the website's dynamic content (Step 200), generate a plurality of keywords relevant to the image (Step 210), generate a root name comprising at least one of the generated keywords (Step 220), and concatenate a top level domain to the root name (Step 230). Each of these steps (200 through 230) may be accomplished as described in detail above.

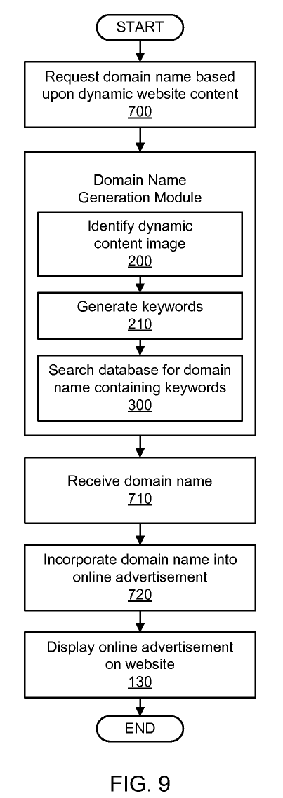

FIG. 9 also builds upon the method illustrated in FIG. 7, wherein, prior to domain name receipt (Step 710), a domain name generation module (described in detail below) may identify at least one image in the website's dynamic content (Step 200), generate a plurality of keywords relevant to the image (Step 210), and search a domain names database for at least one domain name comprising at least one of the keywords (Step 300). Each of these steps (200, 210, and 300) may be accomplished as described in detail above.

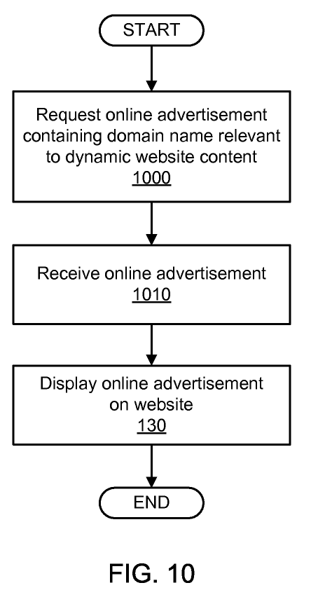

FIGS. 10 through 12 illustrate methods for generating online advertisements offering dynamic content relevant domain names for registration that may provide solutions for an individual or entity having the capacity to provide dynamic website content, but perhaps not the ability to generate online advertisements or domain names relevant to the website's dynamic content. As a non-limiting example, these embodiments may be particularly useful to a website content provider that may not also be an advertising service, domain name registrar, registry, or reseller.

FIG. 10 illustrates a possible embodiment of a method for generating online advertisements offering dynamic content relevant domain names for registration that may comprise the steps of requesting an online advertisement that may offer at least one available domain name (that is based upon a website's dynamic content) for registration (Step 1000), receiving the requested online advertisement (Step 1010), and displaying the online advertisement on the website (Step 130).

The online advertisement may be requested (Step 1000) via any method or means for requesting an online advertisement known in the art or developed in the future. As a non-limiting example, the request may come from any individual or entity having access to a network (perhaps the Internet) that may wish to obtain such an online advertisement. The request may comprise any electronic request received by the server including, but not limited to, a Hyper Text Transfer Protocol (HTTP) request, email message, and/or Short Message Service (SMS) message (i.e., text message). As a non-limiting example, the request may comprise an HTTP request initiated by a website provider who wishes to monetize the dynamic content on his website. The request may be received by any individual or entity having the ability to generate and provide the described online advertisement, such as the above-described advertising service. Alternatively, the electronic request may comprise a function call on a domain name generation module having an exposed Applications Programming Interface (API).

The online advertisement then may be received (Step 1010), perhaps in like electronic format as the request (i.e., an HTTP request receives an HTTP response). Received data identifying the domain name may be in any cognizable data format known in the art or developed in the future and may be received via any method or means for receiving the domain name including, but not limited to, the data and file transfer protocols described in detail above. The received online advertisement then may be displayed on the website (Step 130) as described above.

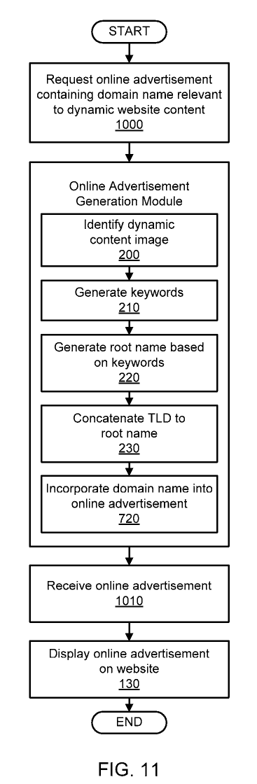

FIG. 11 builds upon the method illustrated in FIG. 10, wherein, prior to online advertisement receipt (Step 1010), an online advertisement generation module (described in detail below) may identify at least one image in the website's dynamic content (Step 200), generate a plurality of keywords relevant to the image (Step 210), generate a root name comprising at least one of the generated keywords (Step 220), concatenate a top level domain to the root name (Step 230), and incorporate the resulting domain name(s) into an online advertisement (Step 720). Each of these steps (200 through 230 and 720) may be accomplished as described in detail above.

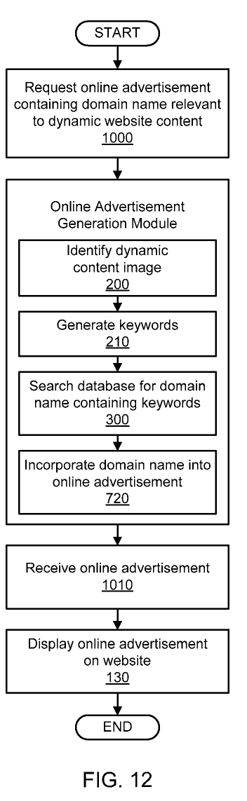

FIG. 12 also builds upon the method illustrated in FIG. 10, wherein, prior to online advertisement receipt (Step 1010), an online advertisement generation module (described in detail below) may identify at least one image in the website's dynamic content (Step 200), generate a plurality of keywords relevant to the image (Step 210), search a domain names database for at least one domain name comprising at least one of the keywords (Step 300), and incorporate the resulting domain name(s) into an online advertisement (Step 720). Each of these steps (200, 210, 300, and 720) may be accomplished as described in detail above.

Systems for Generating Online Advertisements Offering Dynamic Content Relevant Domain Names for Registration

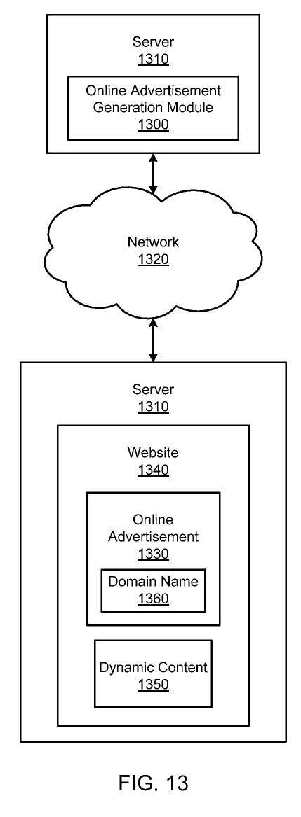

FIG. 13 illustrates a possible embodiment of a system for generating online advertisements offering dynamic content relevant domain names for registration. This example embodiment may comprise an online advertisement generation module 1300 running on at least one server computer 1310 communicatively coupled to a network 1320. The online advertisement generation module 1300 may generate at least one online advertisement 1330 offering for registration at least one domain name 1360, which may be based upon the dynamic content 1350 on a website 1340.

The example embodiments herein place no limitation on network 1320 configuration or connectivity. Thus, as non-limiting examples, the network 1320 could comprise the Internet, the public switched telephone network, the global Telex network, computer networks (e.g., an intranet, an extranet, a local-area network, or a wide-area network), wired networks, wireless networks, or any combination thereof.

Servers 1310 may be communicatively coupled to the network 1320 via any method of network connection known in the art or developed in the future including, but not limited to wired, wireless, modem, dial-up, satellite, cable modem, Digital Subscriber Line (DSL), Asymmetric Digital Subscribers Line (ASDL), Virtual Private Network (VPN), Integrated Services Digital Network (ISDN), X.25, Ethernet, token ring, Fiber Distributed Data Interface (FDDI), IP over Asynchronous Transfer Mode (ATM), Infrared Data Association (IrDA), wireless, WAN technologies (T1, Frame Relay), Point-to-Point Protocol over Ethernet (PPPoE), and/or any combination thereof.

As non-limiting examples, the servers 1310 could be application, communication, mail, database, proxy, fax, file, media, web, peer-to-peer, standalone, software, or hardware servers (i.e., server computers) and may use any server format known in the art or developed in the future (possibly a shared hosting server, a virtual dedicated hosting server, a dedicated hosting server, or any combination thereof). Clients that may be used to connect to the network 1320 to use the illustrated embodiments may include a desktop computer, a laptop computer, a hand held computer, a terminal, a television, a television set top box, a cellular phone, a wireless phone, a wireless hand held device, an Internet access device, a rich client, thin client, or any other client functional with a client/server computing architecture.

At least one of the servers 1310 connected to the network 1320 may host a website 1340 that may provide Internet users with dynamic content 1350. The website 1340 may comprise any collection of data and/or files accessible via a browser on a client having access to a network 1320 communicatively coupled to the server 1310. The dynamic content 1350 available on the website 1340 may comprise any content that is not static. For example, it may comprise any website content (e.g., text, images, photos, video, audio, flash etc.) that may change over time, perhaps in response to different contexts or conditions. Dynamic content 1350 may be generated, as a non-limiting example, via client and/or server-side scripting. Commonly-known examples of dynamic content 1350 include video available via YOUTUBE.COM and/or HULU.COM's websites. The illustrated embodiments may function with any and all sources of dynamic content 1350.

The illustrated system also may comprise an online advertisement generation module 1300 that may be stored in the memory of—and run on—at least one server 1310 and may comprise any software and/or scripts containing instructions that, when executed by the server's 1310 microprocessor, cause the microprocessor to generate at least one online advertisement 1330 that may offer for registration at least one domain name 1360 based upon the dynamic content 1350 on the website 1340. Online advertisements 1330 may comprise any form of online advertising including, but not limited to, text, graphics, video, and/or audio data. The online advertisement 1330 also could comprise a hyperlink to another website, another webpage, and/or both. Among other types, the online advertisement 1330 may be a pop-up, pop-under, banner, rich media (i.e., interactive), contextual, targeted, and/or focused ad that may offer the domain name 1360 for registration. Online advertisements 1330 may be generated via any of the methods and algorithms described in detail above.

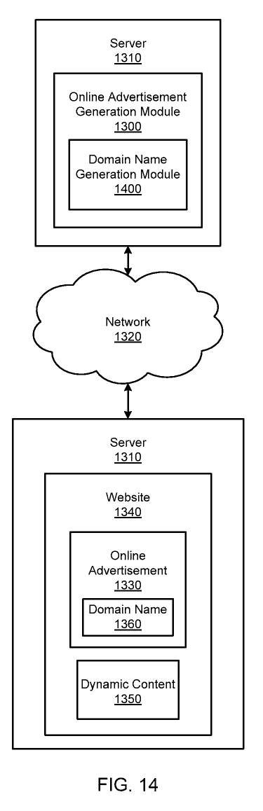

FIG. 14 illustrates an alternate system embodiment that builds upon the system illustrated in FIG. 13. In this example embodiment, the online advertisement generation module 1300 also may comprise a domain name generation module 1400 (also running on at least one server 1310). The domain name generation module 1400 may comprise any software and/or scripts containing instructions that, when executed by the server's 1310 microprocessor, cause the microprocessor to generate domain names 1360 by identifying an image in the website's 1340 dynamic content 1350, generating keywords relevant the image, generating a root name comprising at least one of the keywords, and concatenating a top level domain to the root name. Any of the methods and/or algorithms for generating domain names 1360 described in detail above may be implemented by the domain name generation module 1400.

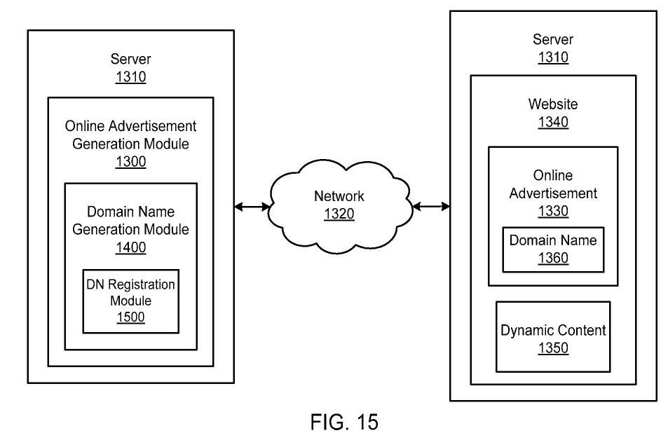

FIG. 15 illustrates an alternate system embodiment that builds upon the system illustrated in FIG. 14. In this example embodiment, the domain name generation module 1400 also may comprise a domain name registration module 1500 (also running on at least one server 1310). The domain name registration module 1500 may comprise any software and/or scripts containing instructions that, when executed by the server's 1310 microprocessor, cause the microprocessor to determine whether the domain name 1360 is available for registration. Any of the methods and/or algorithms for determining the availability of domain names 1360 described in detail above may be implemented by the domain name registration module 1500. In one embodiment, the online advertisement 1330 may offer the domain name 1360 for registration only if the domain name registration module 1500 determines that the domain name 1360 is available for registration.

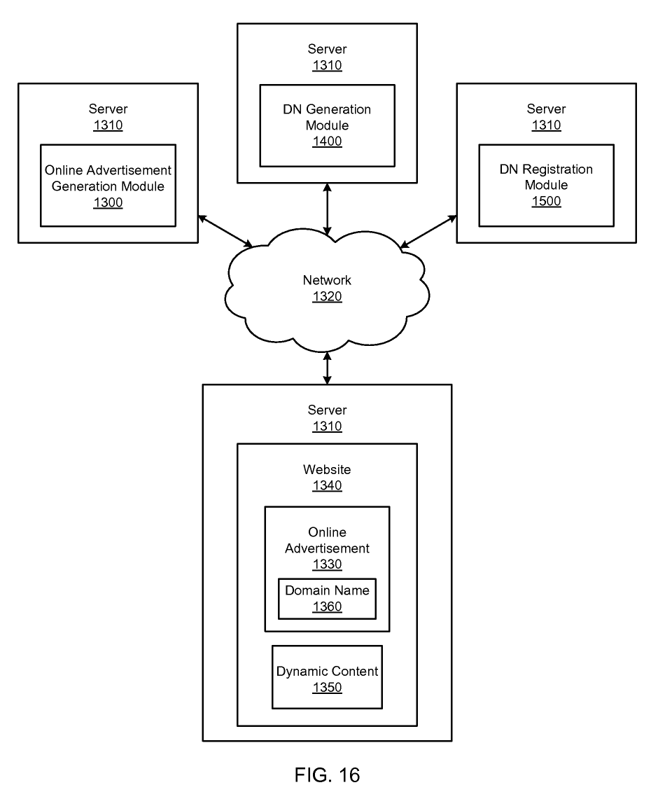

FIG. 16 illustrates a highly-distributed embodiment of a system for generating online advertisements offering dynamic content relevant domain names for registration, wherein the online advertisement generation module 1300, domain name generation module 1400, domain name registration module 1500, and the website 1340 all run on separate servers 1310. In alternate embodiments, each may run on a single server 1310, a grid computing solution, a cloud computing solution, and/or any combination thereof. Grid computing may refer to a network of servers interconnected in a grid and running in parallel to maximize computing power. Cloud computing may refer to a model of networked data storage and/or computing functionality where data and software may be stored and/or run on multiple virtual servers, generally hosted by third parties, rather than being hosted on dedicated servers.

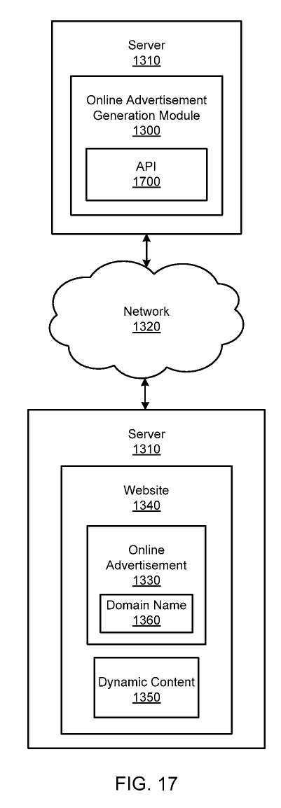

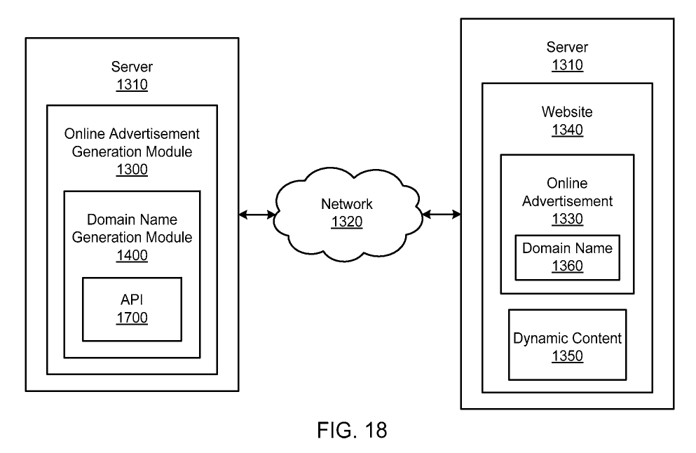

FIG. 17 illustrates an alternate system embodiment that builds upon the system illustrated in FIG. 13, wherein the online advertisement generation module 1300 further comprises an exposed Applications Programming Interface (API) 1700 configured to receive a request for online advertisements 1330. Similarly, FIG. 18 illustrates an alternate system embodiment that builds upon the system illustrated in FIG. 15, wherein the domain name generation module 1400 comprises an API 1700. The API 1700 may comprise a software-to-software interface that specifies the protocol defining how independent computer programs interact or communicate with each other. The API 1700 may allow the requesting entity's software to communicate and interact with the online advertisement generation module 1300 (or domain name generation module 1400, depending upon the utilized configuration)—perhaps over a network such as the Internet—through a series of function calls (requests for services). It may comprise an interface provided by the domain name or online advertisement generation modules (1300 and 1400) to support function calls made of the domain name generation module 1400 by other computer programs, perhaps those utilized by the requesting party to request the described online advertisements 1330.

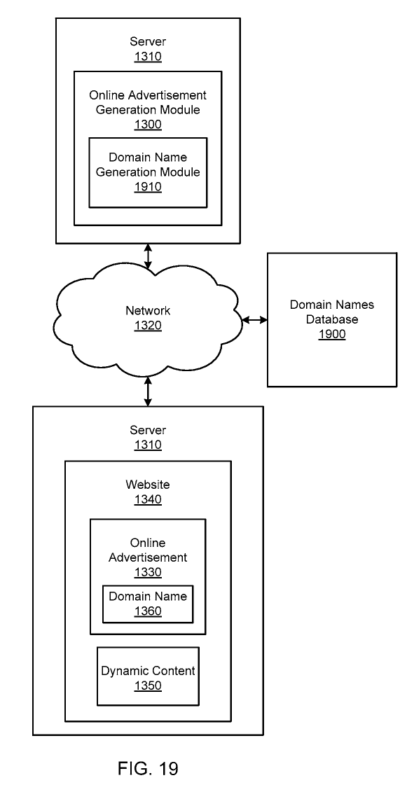

FIG. 19 illustrates an alternate system embodiment that builds upon the system illustrated in FIG. 14, but further comprising a domain names database 1900, which may comprise any network storage device communicatively coupled to the network 1320. This embodiment enables the generation of online advertisements 1330 including those domain names that, although already registered, may be available for re-registration, perhaps because their registration may expire shortly, or because the current domain name owner/registrant wishes to resell his interest in the domain name, perhaps via GODADDY.COM's GODADDY AUCTIONS service.

Accordingly, the domain names database 1900 may comprise a plurality of available domain names, expiring domain names, and/or registered domain names being offered for resale. As non-limiting examples, the domain names database 1900 may comprise a local database, online database, desktop database, server-side database, relational database, hierarchical database, network database, object database, object-relational database, associative database, concept-oriented database, entity-attribute-value database, multi-dimensional database, semi-structured database, star schema database, XML database, file, collection of files, spreadsheet, or other means of data storage located on a computer, client, server, or any other storage device known in the art or developed in the future.

In this example embodiment, the online advertisement generation module 1300 also may comprise a domain name generation module 1910 (also running on at least one server 1310). The domain name generation module 1910 may comprise any software and/or scripts containing instructions that, when executed by the server's 1310 microprocessor, cause the microprocessor to generate domain names 1360 by identifying an image in the website's 1340 dynamic content 1350, generating keywords relevant the image, and searching the domain names database 1900 for at least one domain name 1360 comprising at least one of the keywords. Any of the methods and/or algorithms for generating domain names 1360 described in detail above may be implemented by the domain name generation module 1910.

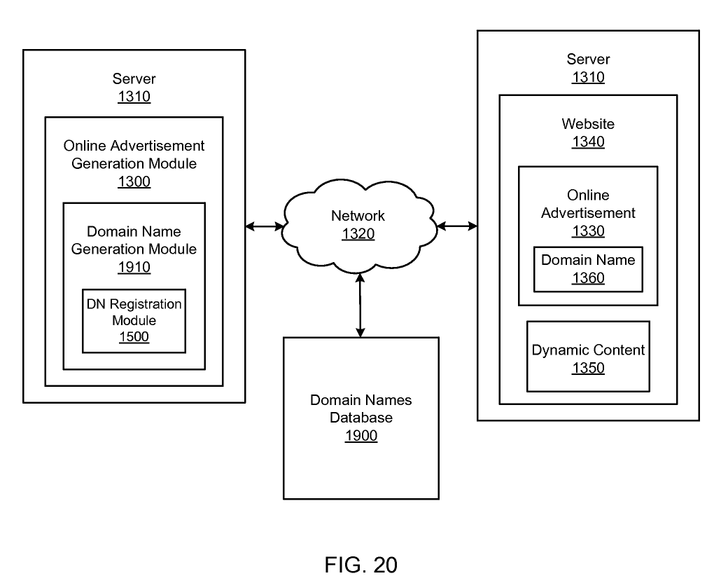

FIG. 20 illustrates an alternate system embodiment that builds upon the system illustrated in FIG. 19, wherein the domain name generation module 1910 further comprises a domain name registration module 1500, which is described in detail above.

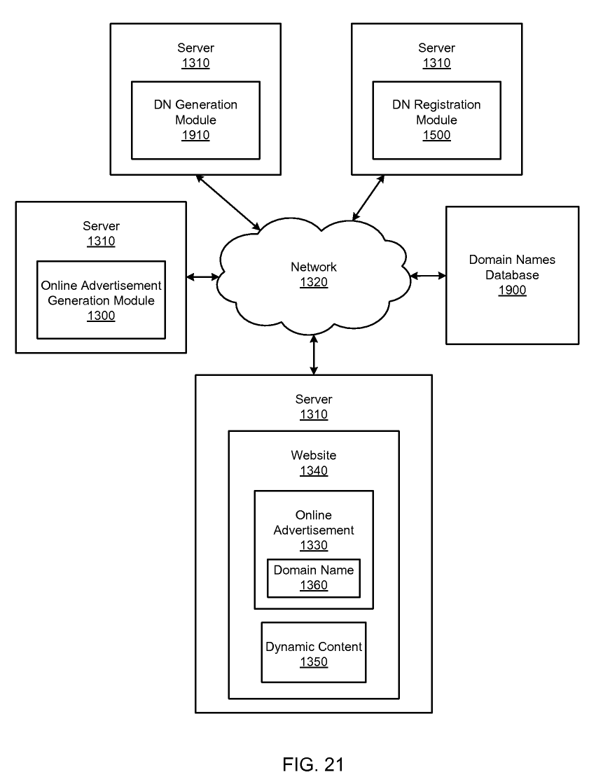

FIG. 21 illustrates a highly-distributed embodiment of the system illustrated in FIG. 20, wherein the online advertisement generation module 1300, domain name generation module 1910, domain name registration module 1500, and the website 1340 all run on separate servers 13 10. In alternate embodiments, each may run on a single server 1310, a grid computing solution, a cloud computing solution, and/or any combination thereof.

Other embodiments and uses of the above inventions will be apparent to those having ordinary skill in the art upon consideration of the specification and practice of the inventions disclosed herein. The specification and examples given should be considered exemplary only, and it is contemplated that the appended claims will cover any other such embodiments or modifications as fall within the true scope of the inventions.

The Abstract accompanying this specification is provided to enable the United States Patent and Trademark Office and the public generally to determine quickly from a cursory inspection the nature and gist of the technical disclosure and in no way intended for defining, determining, or limiting the present inventions or any of its embodiments.

The inventions claimed are:

1. A system, comprising: an online advertisement generation module running on at least one server computer communicatively coupled to a network, said online advertisement generation module generating at least one online advertisement offering for registration at least one domain name based upon a dynamic content on a website.

2. The system of claim 1, wherein said online advertisement generation module further comprises a domain name generation module running on said at least one server computer, wherein said domain name generation module identifies at least one image in said dynamic content, generates a plurality of keywords relevant to said at least one image, generates a root name comprising on at least one of said keywords, and concatenates a top level domain to said root name.

3. The system of claim 2, wherein said top level domain is randomly selected.

4. The system of claim 2, wherein said top level domain is selected based on a concept in said website.

5. The system of claim 2, wherein said domain name generation module further comprises a domain name registration module running on said at least one server computer, wherein said domain name registration module determines whether said at least one domain name is available for registration.

6. The system of claim 5, wherein said online advertisement comprises said at least one domain name only if said domain name registration module determines that said at least one domain name is available for registration.

7. The system of claim 6, wherein said at least one server computer comprises a single server computer.

8. The system of claim 6, wherein said at least one server computer comprises a plurality of server computers.

9. The system of claim 6, wherein said at least one server computer comprises a grid computing solution.

10. The system of claim 6, wherein said at least one server computer comprises a cloud computing solution.

11. The system of claim 1, wherein said online advertisement generation module further comprises an exposed API receiving a request for said at least one online advertisement.

12. The system of claim 2, wherein said domain name generation module further comprises an exposed API receiving a request for said at least one online advertisement.

13. The system of claim 1, wherein said online advertisement generation module further comprises:
A) a domain names database communicatively coupled to said network; and
B) a domain name generation module running on said at least one server computer, wherein said domain name generation module identifies at least one image in said dynamic content, generates a plurality of keywords relevant to said at least one image, and searches said domain names database for at least one domain name comprising at least one of said plurality of keywords.

14. The system of claim 13, wherein said domain name generation module further comprises a domain name registration module running on said at least one server computer, wherein said domain name registration module determines whether said at least one domain name is available for registration.

15. The system of claim 14, wherein said online advertisement comprises said at least one domain name only if said domain name registration module determines that said at least one domain name is available for registration.

16. The system of claim 13, wherein said domain names database comprises a plurality of expiring domain names.

17. The system of claim 13, wherein said domain names database comprises a plurality of registered domain names being offered for resale.

18. The system of claim 15, wherein said at least one server computer comprises a single server computer.

19. The system of claim 15, wherein said at least one server computer comprises a plurality of server computers.

20. The system of claim 15, wherein said at least one server computer comprises a grid computing solution.

21. The system of claim 15, wherein said at least one server computer comprises a cloud computing solution.

22. The system of claim 13, wherein said domain name generation module further comprises an exposed API receiving a request for said at least one online advertisement.

23. A system comprising: an online advertisement generation module running on a cloud computing solution communicatively coupled to a network, said online advertisement generation module generating at least one online advertisement offering for registration at least one domain name based upon a dynamic content on a website, wherein said online advertisement generation module further comprises a domain name generation module running on said cloud computing solution, wherein said domain name generation module identifies at least one image in said dynamic content, generates a plurality of keywords relevant to said at least one image, generates a root name comprising at least one of said keywords, and concatenates a top level domain to said root name, wherein said top level domain is selected based on a concept in said website, wherein said domain name generation module further comprises a domain name registration module running on said cloud computing solution, wherein said domain name registration module determines whether said at least one domain name is available for registration, wherein said online advertisement comprises said at least one domain name only if said domain name registration module determines that said at least one domain name is available for registration.
